(19) United States
(12) Patent Application Publication
(10) Pub. No.: US 2016/0092505 A1
(43) Pub. Date: Mar. 31, 2016

(54) FRAMEWORK FOR HANDLING WRAPPER PROCEDURES

(71) Applicants: Yihan SONG, Shanghai (CN); Qin QIAN, Shanghai (CN); Hongyue XIAO, Shanghai (CN)

(72) Inventors: Yihan SONG, Shanghai (CN); Qin QIAN, Shanghai (CN); Hongyue XIAO, Shanghai (CN)

(21) Appl. No.: 14/499,259

(22) Filed: Sep. 29, 2014

(51) Int. Cl. G06F 17/30

(52) U.S. Cl. CPC G06F 17/30442; G06F 17/30483

(57) ABSTRACT

A framework for handling a wrapper procedure is provided herein. In accordance with one aspect, a user definition of a wrapper procedure encapsulating a stored procedure is received. The framework retrieves metadata associated with the stored procedure. The framework may prepare at least one query statement to invoke the stored procedure using an input parameter identified from the metadata. The framework may further set at least one value of at least one identified input parameter based on the metadata, and execute the prepared query statement using the set value of the input parameter to generate at least one value for an output parameter.

### TECHNICAL FIELD

The present disclosure relates generally to databases and more specifically to handling procedures that encapsulate stored procedures.

### BACKGROUND

A stored procedure is a subroutine that is available to applications that access a relational database system. Stored procedures may include one or more query statements (e.g., Structured Query Language or SQL statements) for managing data stored in the database system. Stored procedures may return result sets upon execution of the query statements. A result set may include, for example, a set of rows from the database system and metadata about the query (e.g., column names, types and sizes of each column, etc.). Stored procedures can receive input variables, return results, modify variables and return them.

Stored procedures provide several advantages. For example, since stored procedure statements are stored directly in the database system, all or part of the compilation overhead may be removed. In addition, stored procedures may run directly within the database engine, thereby avoiding network communication costs. Stored procedures (e.g., SqlScript) provided by in-memory hybrid database platforms, such as the High-Performance Analytic Appliance (HANA) system from SAP SE of Walldorf, Germany, allow the software developer to leverage advanced hardware capabilities to analyze very large volumes of data in real-time.

The exact implementation of stored procedures varies from one database to another. To use the stored procedures efficiently and correctly, the software developer will need expert knowledge to manually prepare procedure parameters, create query statements, and so forth. A middle-layer software developer, for example, typically has extensive knowledge in designing applications using JavaScript functions, but not the expert knowledge to use complex stored procedures provided by the database system to access and manage data. It is often challenging and counterproductive for them to integrate such stored procedures into their applications.

### SUMMARY

A framework for handling a wrapper procedure is provided herein. In accordance with one aspect, a user definition of a wrapper procedure encapsulating a stored procedure is received. The framework retrieves metadata associated with the stored procedure. The framework may prepare at least one query statement to invoke the stored procedure using an input parameter identified from the metadata. The framework may further set at least one value of at least one identified input parameter based on the metadata, and execute the prepared query statement using the set value of the input parameter to generate at least one value for an output parameter.

With these and other advantages and features that will become hereinafter apparent, further information may be obtained by reference to the following detailed description and appended claims, and to the figures attached hereto.

### BRIEF DESCRIPTION OF THE DRAWINGS

Some embodiments are illustrated in the accompanying figures, in which like reference numerals designate like parts, and wherein:

FIG. 1 is a block diagram illustrating an exemplary system;

FIG. 2 shows an exemplary sequence diagram; and

FIG. 3 shows a table of an exemplary sequence of query statements.

### DETAILED DESCRIPTION

In the following description, for purposes of explanation, specific numbers, materials and configurations are set forth in order to provide a thorough understanding of the present frameworks and methods and in order to meet statutory written description, enablement, and best-mode requirements. However, it will be apparent to one skilled in the art that the present frameworks and methods may be practiced without the specific exemplary details. In other instances, well-known features are omitted or simplified to clarify the description of the exemplary implementations of the present framework and methods, and to thereby better explain the present framework and methods. Furthermore, for case of understanding, certain method steps are delineated as separate steps; however, these separately delineated steps should not be construed as necessarily order dependent in their performance.

A framework for handling wrapper procedures is described herein. A wrapper procedure is a subroutine that wraps or encapsulates a stored procedure. In accordance with one aspect, the framework advantageously enables a user or software developer to define the wrapper procedure and customize various aspects according to the requirements of different scenarios. The framework then automatically handles the execution of the wrapper procedure upon its invocation. For example, the framework may automatically retrieve metadata associated with the stored procedure, prepare query statements, set values of identified input parameters, execute prepared query statements to retrieve or manage data from the database server, return one or more values of input/output parameters, output parameters and/or native output, and so forth.

A native output is a local variable defined within the stored procedure (e.g., generated by a SELECT query statement), and not defined and passed into the stored procedure as an output parameter. Native output may be important in some cases, such as dynamic SQL, various output, etc. Unlike previous work, these native output values may be returned by the wrapper procedure call if desired. The present framework advantageously handles both output parameters and native outputs seamlessly. The query statements in the stored procedure may be consumed without assigning the native output to an output parameter.

In addition, the productivity of the user or developer is greatly enhanced by simplifying the coding process. The user can focus on, for example, business logic processing, without worrying about how to prepare or handle procedure parameters for the stored procedure. The user can easily invoke the stored procedure by calling the wrapper procedures as if they were plain functions in a common computer programming language (e.g., JavaScript). The user may also customize the wrapper procedure to, for example, use a specific database connection, library, specify whether to use bulk insert to optimize performance, name the native output, and so forth.

The framework described herein may be implemented as a method, computer-controlled apparatus, a computer process, a computing system, or as an article of manufacture such as a computer-usable medium. These and various other features will be apparent from the following description.

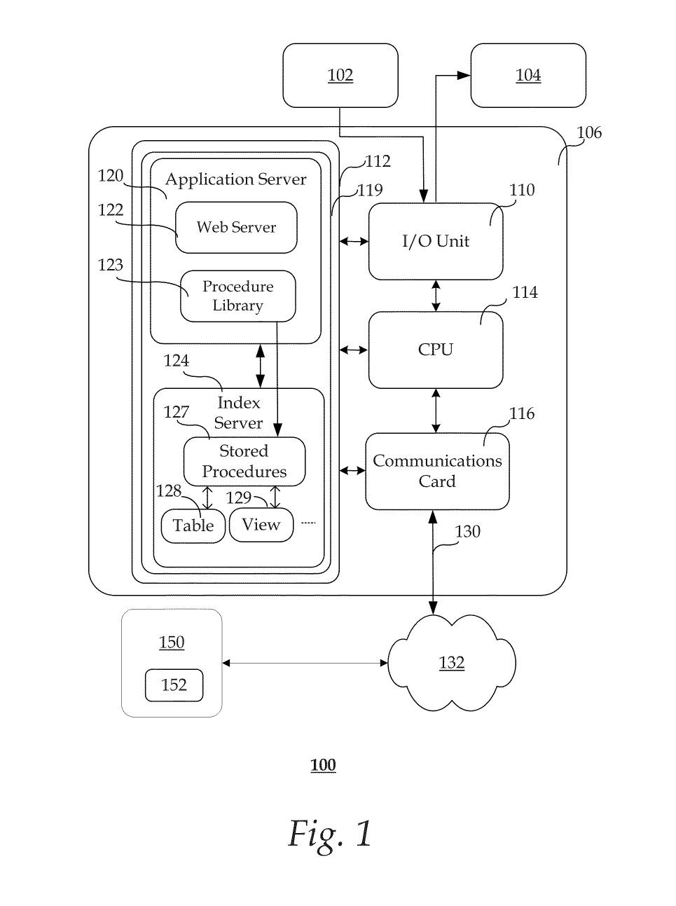

FIG. 1 shows a block diagram illustrating an exemplary system 100 that may be used to implement the framework described herein. System 100 may include a computer system 106 communicatively coupled to an input device 102 (e.g., keyboard, touchpad, microphone, camera, etc.) and an output device 104 (e.g., display device, monitor, printer, speaker, etc.). Computer system 106 also may include a communications card or device 116 (e.g., a modem and/or a network adapter) for exchanging data with network 132 using a communications link 130 (e.g., a telephone line, a wireless network link, a wired network link, or a cable network). Network 132 may be a local area network (LAN) or a wide area network (WAN). The computer system 106 may be communicatively coupled to one or more other computer systems via network 132. For example, computer system 106 may act as a server and operate in a networked environment using logical connections to one or more client computers 150. Client computer 150 may include a user interface 152 for accessing the services provided by computer system 106.

Computer system 106 includes a central processing unit (CPU) 114, an input/output (I/O) unit 110, and a memory module 112. Other support circuits, such as a cache, a power supply, clock circuits and a communications bus, may also be included in computer system 106. In addition, any of the foregoing may be supplemented by, or incorporated in, application-specific integrated circuits. Examples of computer system 106 include a handheld device, a mobile device, a personal digital assistance (PDA), a workstation, a server, a portable laptop computer, another portable device, a mini-computer, a mainframe computer, a storage system, a dedicated digital appliance, a device, a component, other equipment, or some combination of these capable of responding to and executing instructions in a defined manner.

Memory module 112 may be any form of non-transitory computer-readable media, including, but not limited to, dynamic random access memory (DRAM), static random access memory (SRAM), Erasable Programmable Read-Only Memory (EPROM), Electrically Erasable Programmable Read-Only Memory (EEPROM), flash memory devices, magnetic disks, internal hard disks, removable disks, magneto-optical disks, Compact Disc Read-Only Memory (CD-ROM), any other volatile or non-volatile memory, or a combination thereof.

Memory module 112 serves to store machine-executable instructions, data, and various software components for implementing the techniques described herein, all of which may be processed by CPU 114. As such, the computer system 106 is a general-purpose computer system that becomes a specific-purpose computer system when executing the machine-executable instructions. Alternatively, the various techniques described herein may be implemented as part of a software product, which is executed via an application server 120. Each computer program may be implemented in a high-level procedural or object-oriented programming language (e.g., C, C++, Java, etc.), or in assembly or machine language if desired. The language may be a compiled or interpreted language. The machine-executable instructions are not intended to be limited to any particular programming language and implementation thereof. It will be appreciated that a variety of programming languages and coding thereof may be used to implement the teachings of the disclosure contained herein.

In one implementation, the memory module 112 of the computer system 106 includes an in-memory database management system 119. An in-memory database is a database management system that primarily relies on main memory for computer data storage. It is contrasted with database management systems that employ a disk storage mechanism. One example of an in-memory database is the HANA (high performance analytic appliance) system from SAP SE of Walldorf, Germany. The in-memory database management system 119 allows seamless access to and propagation of high volumes of data in real-time. Parallel processing may further be achieved by using a multicore processor in conjunction with the in-memory database 119.

The in-memory database 119 may include an application server 120 and an index server 124. The application server 120 provides services to build and/or deploy applications. One example of an application server is the HANA Extended Application Services (also known as XS or XS Engine) from SAP SE. The application server 120 may include a web server 122 and a procedure library 123. The web server 122 may provide, for example, representational state transfer (REST) services for building or deploying web application programming interfaces (APIs). The procedure library 123 is a collection of resources for invoking stored procedures and defining wrapper procedures. For example, the procedure library 123 may serve to handle various stored procedure invocation requests, including parameter preparation, result wrapper, and so forth. More details of these exemplary features will be provided in the following description.

The index server 124 may contain the actual data and stored procedures 127 for managing the data. It may also coordinate and use all the other servers. The actual data may be organized in, for example, tables 128 or views 129. Column-based data storage may further be implemented, wherein data tables 128 are stored as columns of data, in sequence and in compressed memory blocks. This may facilitate faster aggregation of data when calculations are performed on single columns. Alternatively, row-based data storage is also possible. In some implementations, instead of updating entire rows, only fields that have changed will be updated. This avoids having to lock entire data tables during updates to prevent conflicting modifications to a set of data. High levels of parallelization may be achieved, which is critical to real-time processing of live data streams and performing constant and substantially simultaneous updates.

It should be appreciated that the different components of the computer system 106 may be located on different machines. For example, the application server 120 and the index server 124 may be implemented on different physical machines or computer systems. It should further be appreciated that the different components of the client computer 150 may also be located on the computer system 106.

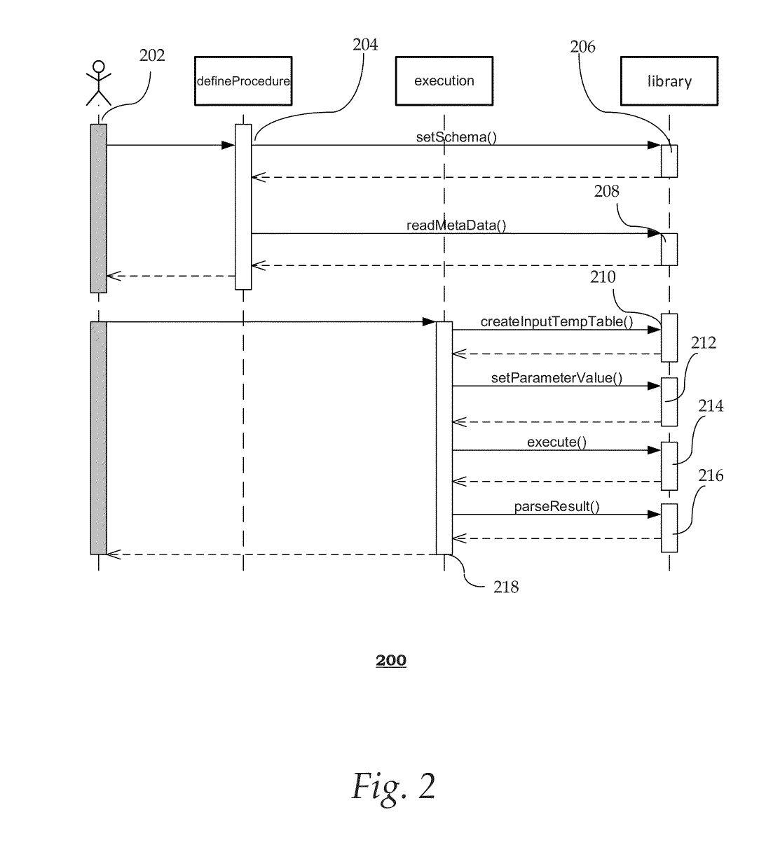

FIG. 2 shows an exemplary sequence diagram 200 for handling wrapper procedures. It should be noted that the steps in the sequence diagram 200 may be performed in the order shown or a different order. Furthermore, different, additional or fewer steps may be implemented. Even further, the steps may be implemented with the system 100 of FIG. 1, a different system, or a combination thereof. In the following discussion, reference will be made, using like numerals, to the features described in FIG. 1.

At 202, the user (or software developer) defines a wrapper procedure based on a stored procedure. As discussed previously, a stored procedure is a subroutine that is available to applications that access a relational database system. For instance, the developer working on data modeling may provide a stored procedure for the application developer to integrate with a user interface.

An exemplary stored procedure “SAP_TEST”. “sap.test.sample::dummy_arr” (hereinafter “SAP_TEST”) is shown as follows:

```
PROCEDURE “SAP_ TEST”.“sap.test.sample::dummy_arr” (
  IN var1 VARCHAR(32),
  IN arr “SAP_TEST”.“sap.test.sample::tt_input”,
  OUT user VARCHAR(32),
  OUT out_arr “SAP_ TEST”.“sap.test.sample::tt_output”
)
  LANGUAGE SQLSCRIPT
  SQL SECURITY INVOKER
  DEFAULT SCHEMA “SAP_ TEST”
AS
BEGIN
  SELECT CURRENT_USER INTO user FROM DUMMY;
  SELECT SESSION_USER FROM DUMMY;
  out_arr = SELECT * FROM :arr;
  SELECT ‘SESSION_USER2’ AS NAME FROM DUMMY;
END;
```

An exemplary table type definition for tt_input may be as follows:

CREATE TYPE “SAP_TEST”.“sap.test.sample::tt_input” AS TABLE
( “ID” INT CS_INT NOT NULL, “NAME” NVARCHAR(100)
CS_STRING )

An exemplary table type definition for tt_output may be as follows:

CREATE TYPE “SAP_TEST”.“sap.test.sample::tt_output” AS TABLE
( “ID” INT CS_INT NOT NULL, “NAME” NVARCHAR(100)
CS_STRING )

From the above exemplary definitions, it can be observed that the exemplary stored procedure accepts two input parameters: (1) var1, which is a 32 length string, and (2) “SAP_TEST”.“sap.test.sample::tt_input”, which is a table. The stored procedure returns two output parameters: (1) user, which is a 32 length string, and (2) “SAP_TEST”.“sap.test.sample::tt_output”, which is a table. Inside the stored procedure, there are two native outputs generated by the SELECT statements.

The user may define a wrapper procedure based on the stored procedure. In some implementations, the procedure library 123 enables the user to construct the wrapper procedure by providing a procedure constructor. First, the user may import the procedure library 123 by providing the following exemplary statement in the code:

var proc=$.import(“./xslib/procedures.xsjslib”);

Subsequently, the user may construct the wrapper procedure using the following exemplary procedure constructor (e.g., new proc.procedure), which is in a form of, for example, a JavaScript statement:

```
var dummy = new proc.procedure(
“SAP_TEST”,
“sap.test.sample::dummy_arr”,
{
    namedNativeOutputs: [“OUT1”, “OUT2”],
    enableBulkInsert: true,
    connection: $.db.getConnection( ),
    tempSchema: $.session.getUsername( )
}
);
```

As shown, the exemplary procedure constructor accepts three types of parameters: (1) database schema to be used by the stored procedure, (2) stored procedure name, and (3) configuration data. It should be appreciated that other types of parameters may also be accepted. The configuration data enables the user to customize various aspects of the stored procedure to, for example, optimize performance. The configuration data may include, for example, names of native outputs (e.g., OUT1 and OUT2), control parameter (e.g., enableBulkInsert) to enable importation of bulk data so as to optimize performance for any table-type input parameter, database connection parameter (e.g., connection) to pass an outside database connection into the library instead of using the stored procedure's own connection, and the database schema according to which a temporary table may be created. Other types of configuration data may also be provided. For example, a control parameter (e.g., inputTableType:“LOCAL”) may be provided to indicate that a local temporary table is to be created for a table-type input parameter. A local temporary table exists only for the duration of the procedure that created the temporary table. Alternatively, a global temporary table may be specified. A global temporary table also exists for the duration of the procedure that created the table. However, unlike a local temporary table, multiple users can access a global temporary table. A global temporary table may avoid creation each time, and therefore achieve better performance.

At 204, the wrapper procedure is invoked (or called). In some implementations, the wrapper procedure is invoked as if it were a plain function written in a common programming language (e.g., JavaScript). The user may invoke the wrapper procedure (e.g., dummy) by inserting the following exemplary statements into the software program code:

var arr = [{ID: 1, NAME: $.session.getUsername( )}, {ID: 2,
NAME: “$.session.getUsername( )”}];
var output = dummy($.session.getUsername( ), arr);

At 206, the procedure library 123 starts handling the wrapper procedure by setting the database schema. A database scheme generally refers to the structure or organization of a database system described in a formal language supported by the database management system. As discussed previously, the user may specify the database schema via the wrapper procedure constructor. The procedure library 123 may use a default schema if the user does not specify any while defining the wrapper procedure. The default schema may be in the form of, for example, views, tables, other procedures, triggers, etc.

At 208, the procedure library 123 retrieves metadata associated with the stored procedure. Such metadata contains information about one or more aspects (e.g., parameters) of the stored procedure. The following Table 1 shows exemplary metadata that may be associated with the stored procedure:

TABLE 1

| Column | Description |
|---|---|
| DATA_TYPE_NAME | The data type of the parameter, like |
| | INTEGER, VARCHAR |
| PARAMETER_TYPE | Parameter mode: IN, OUT, INOUT |
| TABLE_TYPE_SCHEMA | Schema name of table type if |
| | DATA_TYPE_NAME is |
| | TABLE_TYPE |
| TABLE_TYPE_NAME | Name of table type if |
| | DATA_TYPE_NAME is |
| | TABLE_TYPE |
| PARAMETER_NAME | The parameters name |
| POSITION | Ordinal position of the parameter |

In some implementations, the procedure library 123 retrieves the metadata from a system table, view or any other data structure. Query statements may be prepared and executed to retrieve the metadata. For example, the following query statements may be prepared and executed to retrieve the metadata shown in Table 1:

SELECT DATA_TYPE_NAME, PARAMETER_TYPE,
TABLE_TYPE_SCHEMA, TABLE_TYPE_NAME,
PARAMETER_NAME, POSITION FROM
PROCEDURE_PARAMETERS
WHERE PROCEDURE_NAME = ? AND SCHEMA_NAME = ?
ORDER BY POSITION ASC

The procedure library 123 automatically parses the metadata to identify any parameters, parameter types and values thereof. The procedure library 123 may parse the metadata (e.g., PARAMETER_TYPE) to distinguish input and output parameters identified from the metadata. Procedure-defined input (IN) parameters are used to pass values into the stored procedure, while procedure-defined output (OUT) parameters are used to pass values out of the stored procedure. Procedure-defined input/output (INOUT) parameters are bidirectional parameters that may be used to pass values into and out of the stored procedure. Both IN and INOUT parameters may be treated as input parameters, while both OUT and INOUT parameters may be treated as output parameters. Unlike prior work, the wrapper procedure advantageously supports bidirectional input/output (INOUT) parameters. Prior work may treat INOUT parameters as neither input nor output parameters, thereby resulting in failed procedure invocations.

The procedure library 123 may determine the type (e.g., scalar or table type) of the input parameter based on the metadata. If there is any table-type input parameter, the procedure library 123 retrieves the definition of the table. The table definition may be retrieved from, for example, a system view (e.g., TABLE_COLUMNS). The procedure library 123 may prepare and execute a query statement to retrieve the table-type definition. An exemplary query statement is as follows:

SELECT COLUMN_NAME, DATA_TYPE_NAME,
IS_NULLABLE, POSITION FROM TABLE_COLUMNS WHERE
TABLE_NAME = ? AND SCHEMA_NAME = ? ORDER BY
POSITION ASC

At 210, the procedure library 123 creates a temporary input table for storing any table-type input parameter. The temporary input table may be created using the table-type definition of the input parameter, as previously determined from the metadata. The temporary input table may advantageously be customized according to different requirements. For example, the user may specify a local or global temporary table, a format of the table (e.g., column/row), a vendor-specific type of table (e.g., HANA partition table, virtual table, etc.), and so forth.

The procedure library 123 may create a local temporary input table by preparing and invoking the following exemplary table construction statement, without the need to parse the table-type definition:

CREATE LOCAL TEMPORARY TABLE
“YIHAN”.“#ARR_1403674867446” LIKE
“SAP_TEST”.“sap.test.sample::tt_input”

The statement may fail if the table-type is a SYNONYM under the database schema. Therefore, the procedure library 123 may first check whether any row exists in the synonym view by the given name. If there is none, the given name is used directly; otherwise, the object name associated with the SYNONYM is used.

In some implementations, the procedure library 123 prepares a statement to call the stored procedure using the identified input parameter or temporary input table. A stored procedure is typically called using the following syntax:

CALL <proc_name> (<param_list>) [WITH OVERVIEW]
[IN DEBUG MODE]

Calling a procedure using “WITH OVERVIEW” returns the result of the stored procedure call stored directly into a physical table. Scalar outputs may be represented as temporary tables with only one cell. When existing tables are passed to the output parameters, WITH OVERVIEW may insert the result set tuples of the procedure into the provided tables. When NULL is passed to the output parameters, temporary tables holding the result sets may be generated. These tables may be automatically dropped once the database session is closed. WITH OVERVIEW may not be used to lazy load the output, since it will suppress any native output selected in the procedure. Additionally, in order to optimize performance, IN DEBUG MODE should not be used, since it will generate additional debug information.

Accordingly, in some implementations, procedure library 123 may prepare the following statement to invoke the stored procedure using the temporary input table that has previously been created:

CALL
“SAP_TEST”.“sap.test.sample::dummy_arr”(?,
“YIHAN”.“#ARR_1403674346536”,?,?)

At 212, the procedure library 123 sets at least one value of at least one input parameter based on the metadata identified at step 208. The procedure library 123 may loop through the identified input parameters and set the respective values. There may be two different types of values: (1) scalar, such as basic SQL type, (e.g., INTEGER, DATETIME, VARCHAR, etc.); and (2) table, for a table-type input parameter. Scalar values may be set by, for example, invoking a database system API (e.g., HANA XS API). Table values may be set by invoking a batch insert API to optimize performance. A batch insert API imports batches of data (e.g., many rows) into a temporary input table. It greatly increases performance by reducing communication between the application and index servers.

At 214, the procedure library 123 executes the prepared statements with the one or more set values to invoke the stored procedure and generate the output result set. The output result set may include two types of output: (1) procedure-defined output parameters (e.g., OUT and INOUT); and (2) native output selected within the stored procedure. The corresponding values of the defined output parameters may be directly obtained by invoking the application API. With respect to the native output, different strategies may be employed. Since neither the sequence nor the data structure of the native output are known, the CallableStatement may be looped until no more results are returned (i.e., getMoreResults( ) return false). In some implementations, the user may configure the names of the native outputs via the procedure constructor. If the names of the native outputs are not specified by the user, they may be identified with default names (e.g., _VAR_OUT_1_, _VAR_OUT_2_, . . . , etc.).

At 216. the procedure library 123 parses the output result set and returns the output values. The user may then perform any other operation based on the output values (e.g., transform to other format).

For instance, in the aforementioned exemplary wrapper procedure “dummy” for the stored procedure “SAP_TEST”, the procedure library 123 may insert the content of the input parameter array into a temporary table (e.g., arr), pass the table name into the stored procedure, and parse the outputs into the output variable (e.g., var output). The output of the stored procedure may be as follows:

```
{
    “USER”: “YIHAN”,
    “OUT_ARR”: [
      {
        “ID”: 1,
        “NAME”: “YIHAN”
      },
      {
        “ID”: 2,
        “NAME”: “$.session.getUsername( )”
      }
    ],
    “OUT1”: [
      {
        “SESSION_USER”: “YIHAN”
      }
    ],
    “OUT2”: [
      {
        “NAME”: “SESSION_USER2”
      }
    ]
}
```

At 218, the procedure library 123 frees the resources used in the handling. The procedure library 123 may automatically clean the memory space used for the temporary table, release database connection if maintained by the library itself, and so forth.

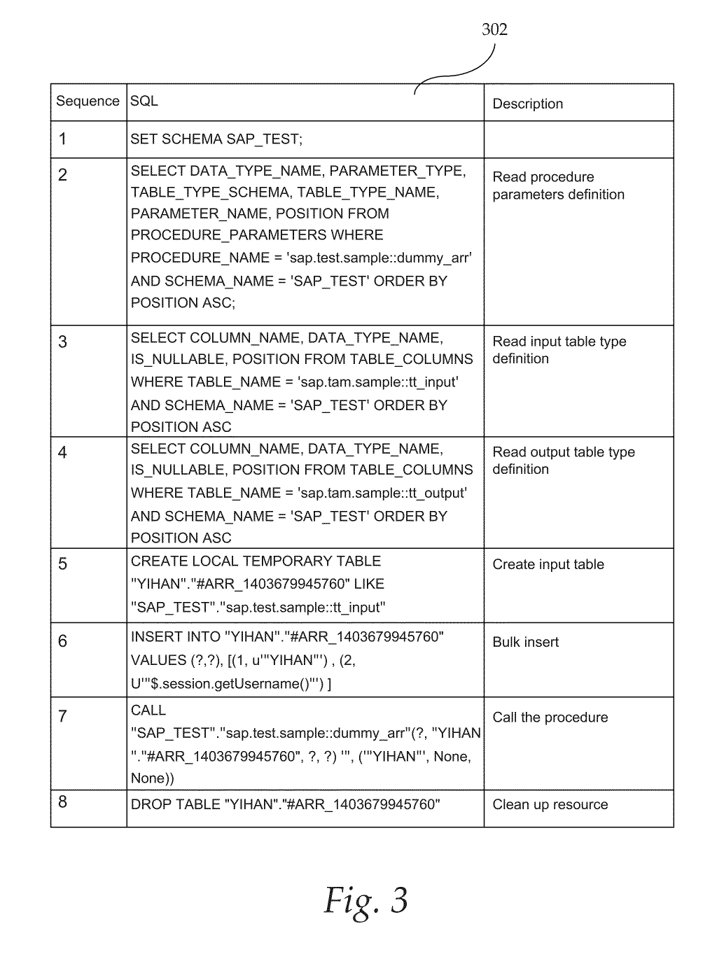

FIG. 3 shows a table 302 of a sequence of exemplary query statements. The sequence of exemplary query statements may be prepared and executed by the procedure library 123 to handle the exemplary wrapper procedure associated with the stored procedure SAP_TEST. The description of each query statement is shown. It should be appreciated that other statements may also be automatically prepared and executed by the procedure library 123 to handle wrapper procedures.

Although the one or more above-described implementations have been described in language specific to structural features and/or methodological steps, it is to be understood that other implementations may be practiced without the specific features or steps described. Rather, the specific features and steps are disclosed as preferred forms of one or more implementations.

1. A computer usable medium having a computer readable program code tangibly embodied therein, the computer readable program code adapted to be executed by a processor to implement a method for handling a wrapper procedure, comprising:
receiving a user definition of the wrapper procedure encapsulating a stored procedure, wherein the user definition comprises at least one control parameter that configures a temporary input table;
retrieving metadata associated with the stored procedure;
creating the temporary input table for storing a table-type input parameter identified from the metadata;
preparing at least one query statement to invoke the stored procedure using the temporary input table;
setting multiple values of the table-type input parameter based on the metadata; and
executing the prepared query statement using the set values and generating at least one value for an output parameter.

2. The computer usable medium of claim 1, wherein the output parameter comprises a native output.

3. The computer usable medium of claim 1, wherein the control parameter specifies whether the temporary table is local or global.

4. The computer usable medium of claim 1, wherein the control parameter specifies a format of the temporary table.

5. A computer-implemented method of handling a wrapper procedure, comprising:
receiving, by a processor, a user definition of the wrapper procedure encapsulating a stored procedure;
retrieving, by the processor, metadata associated with the stored procedure;
preparing, by the processor, at least one query statement to invoke the stored procedure using an input parameter identified from the metadata;
setting, by the processor, at least one value of at least one identified input parameter based on the metadata; and
executing, by the processor, the prepared query statement using the set value of the input parameter and generating at least one value for an output parameter identified from the metadata.

6. The method of claim 5, further comprising:
providing a procedure constructor configured to define the wrapper procedure, wherein the procedure constructor accepts configuration data for user customization of the stored procedure.

7. The method of claim 6, wherein the configuration data includes at least one name of a native output.

8. The method of claim 6, wherein the configuration data includes at least one control parameter configured to enable importation of bulk data.

9. The method of claim 6, wherein the configuration data includes at least one database connection parameter.

10. The method of claim 6, wherein the configuration data includes at least one database schema.

11. The method of claim 6, wherein the configuration data includes at least one control parameter that configures a temporary table created for storing a table-type input parameter.

12. The method of claim 11 wherein the control parameter specifies whether the temporary table is local or global.

13. The method of claim 6, wherein the procedure constructor accepts a database schema to be used by the stored procedure and a name of the stored procedure.

14. The method of claim 5, wherein the input parameter comprises an input/output parameter that passes at least one value into and out of the stored procedure.

15. The method of claim 5, further comprising retrieving a table definition in response to determining the input parameter is a table-type input parameter.

16. The method of claim 15, wherein setting the value of the table-type input parameter comprises importing multiple values by batches into a temporary table.

17. The method of claim 5, wherein the output parameter comprises a native output selected within the stored procedure.

18. The method of claim 5, further comprising freeing resources used in handling of the wrapper procedure.

19. A system comprising:
a non-transitory memory device for storing computer readable program code; and
a processor in communication with the memory device, the processor being operative with the computer readable program code to:
receive a user definition of the wrapper procedure encapsulating a stored procedure;
retrieve metadata associated with the stored procedure;
prepare at least one query statement to invoke the stored procedure using an input parameter identified from the metadata;
set at least one value of at least one identified input parameter based on the metadata; and
execute the prepared query statement using the set value of the input parameter and generate at least one value for an output parameter identified from the metadata.

20. The system of claim 19, wherein the input parameter comprises an input/output parameter.
